(19) United States
(12) Patent Application Publication
(10) Pub. No.: US 2004/0239871 A1
(43) Pub. Date: Dec. 2, 2004

(54) Proposal for Eyeview (previously named skyview)

(76) Inventor: Steve Gesser, Greenwich, CT (US)

Correspondence Address: Steve Gesser, 84 Greenwich Hills Dr., Greenwich, CT, 06831, US

(21) Appl. No.: 10/713,666

(22) Filed: Mar. 2, 2004

Related U.S. Application Data
(60) Provisional application No. 60/473,725, filed on May 28, 2003.

(51) Int. Cl. G02C 1/00

(52) U.S. Cl. 351/41

(57) ABSTRACT

The principal behind Eyeview is to include an eyeglass prescription in a small ring that can be attached to the front of an eyepiece used with telescopes, microscopes or any optical system. As a result, eyeglasses will no longer be needed in order to see correctly.

### BRIEF DESCRIPTION

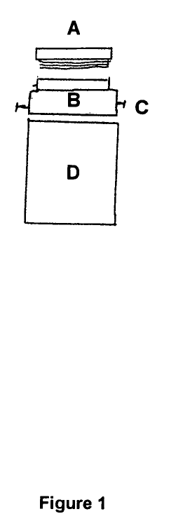

The following refers to the diagram in FIG. 1.

A Threaded eyepiece containing eyeglass prescription

B Clamping device between threaded eyepiece and lens

C Clamping screws

D Lens—i.e., telescope, microscope, etc.

### SUMMARY OF THE INVENTION

When a person who wears glasses looks through a lens (for example, a telescope, microscope, lensometer, etc.), he must remove his glasses to provide eye relief; otherwise, he suffers from vignetting (tunnel vision). The present invention has been achieved in view of this problem.

Eyeview provides a person's prescription in a device that can attach in front of the lens, allowing the person to see more clearly.

### DETAILED DESCRIPTION

A person's eyeglass prescription will be needed in order to make the Eyeview. The lens will be made from ophthalmic glass with a center no thinner than 2.0 millimeters. After the lens is edged to the appropriate diameter, it must be hardened by either heat or chemical tempering. It will then be covered with an antireflective coating and inserted into the threaded device that holds it in place. In the case of prescriptions with astigmatism, a marker (white dot, x, etc . . . ) will indicate the placement of axis for a sphero—cylindrical correction.

Typically the Eyeview will be thirty millimeters in diameter with the ring depth of ten millimeters. The lens will be held in place by two threaded rings on either side of the lens. Finally the Eyeview will be held in place by either three threaded screws at the base, threads or a clamping device.

1. What I claim is my invention is an optical device that provides convenience for those dependent on eyewear to no longer be hampered by their glasses. The Eyeview allows people who would normally use glasses to see clearly without them whenever they look through a lens attached to such instruments as telescopes, microscopes, lensometers, etc.
